(19) United States
(12) Patent Application Publication
(10) Pub. No.: US 2019/0138339 A1
(43) Pub. Date: May 9, 2019

(54) System and Method of Distributed Information Processing using an enhanced data container

(71) Applicants: Andrew John Hacker, Enola, PA (US); Mathhew B Hykes, Middletown, PA (US); Samuel L Jones, Carlisle, PA (US); Philip A Grim, Wellsville, PA (US)

(72) Inventors: Andrew John Hacker, Enola, PA (US); Mathhew B Hykes, Middletown, PA (US); Samuel L Jones, Carlisle, PA (US); Philip A Grim, Wellsville, PA (US)

(21) Appl. No.: 16/178,066

(22) Filed: Nov. 1, 2018

Related U.S. Application Data
(60) Provisional application No. 62/707,536, filed on Nov. 7, 2017.

(51) Int. Cl. G06F 9/455; G06F 9/50

(52) U.S. Cl. CPC G06F 9/45558; G06F 2009/45562; G06F 9/5077

(57) ABSTRACT

A variety of tools and techniques are disclosed for creating and managing a distributed information processing system. The distributed information processing system is comprised of information, data, applications, algorithms, and models that when processed interact with a variety of computing devices and computing device components. These technologies bring additional functionality and levels of interaction to information processing and provide efficient and valuable information patterns, insight, and knowledge to consumer and business applications.

### CROSS-REFERENCE TO RELATED APPLICATIONS

2013 May 8 U.S. Ser. No. 13/889,348 Application

2016 Sep. 27 U.S. Pat. No. 9,454,398B2 Grant, November 2 provisional 62/707,536

### FEDERALLY SPONSORED RESEARCH OR DEVELOPMENT

Not Applicable

### SEQUENCE LISTING OR PROGRAM

Not Applicable

### BACKGROUND OF THE INVENTION

### Field of the Invention

The prevent invention relates to a system and method for improving computer systems using enhanced data containers with extensible characteristics.

### Prior Art

Until the last 80 years or so, humans could create and analyze data with simple tools such as paper, pencils and books. Since that time, the amount of data needed to perform tasks, even the most routine tasks, has greatly outweighed the ability of humans to organize and process without the assistance of machines. Every year, there is more data to sift through and more complex algorithms necessary to process the data.

The need for strong and effective data analytics and artificial intelligence algorithms is growing and pattern recognition in large data sets is even increasingly more crucial today as people, computers, sensors, and devices, among other things, create unimaginable amounts of data. The challenge today as it was then now is to create efficient and effective layers of interpretation for the data. The modern world is no different; in our current state we simply have more data to sift through. It will only increase with time.

Until now, businesses and individuals have managed all of this data as though it were a static stream of matter, indistinct and undistinguished. All data is created equal until it is sifted and categorized by insight engines; and that data is growing exponentially. The reason is simple: Data is inherently inanimate, and only becomes valuable within the context of a program. As humans and machines continue to produce more data, these associated programs have scaled into massive, cumbersome systems with entire enterprises fashioned around them. At the same time, the amount of data created is growing exponentially. This adds up to a landscape littered with programs, too much data and insufficient intelligence to handle it. Going forward, the current paradigm will no longer be scalable, extensible, adaptable or smart enough to cope with the massive influx of information being generated.

Even with the progress these industries have made, existing technology faces significant ongoing challenges and inefficiencies, including training, the black box problem, and transparency and privacy.

Traditionally artificial intelligence uses neural networks and models that require extensive training on how to sift and interpret massive data sets. Finding the right training data and the time it takes to train algorithms with that data is a large encumbrance to truly responsive and ultimately effective artificial intelligence. Without the right training data or appropriate training time, these neural networks and models have diminished effectiveness.

Another problem is the “black box problem,” which is faced by sufficiently complex artificial intelligence networks. This problem can be described by the difficulty in determining the validity of the outputs of artificial intelligence networks. Artificial intelligence networks are too complex to understand how the outputs were derived. This means it is hard to detect tampering, hacking or other malicious activity.

Current technology, such as artificial intelligence, also currently sits centralized in the hands of a few. With large monopolistic platforms having access to all of the data that can then be used with to power their artificial intelligence applications, the common user has no insight into how these algorithms are operating and what is being done with their outputs.

Traditional information processing models keep data and applications separate leading to siloed data stores and siloed applications. In extreme cases applications and strong artificial intelligence algorithms are operated by a monopoly of large corporations.

### Objects and Advantages

In order to simplify complexity while increasing usefulness of information, this invention creates a distributed information processing system offering multiple advantages over prior art without limitation including: a) Bringing functionality closer to the information resulting in more granular control, faster execution, and better ability to manipulate the information. b) Allowing for improvements in or changes to information processing without the complexity of redesigning the underlying application or system. c) Greater protection, tracking, privacy and integrity of information d) More interactivity of or with the information e) Greater interoperability with multiple systems and applications f) Ability to have finer control over creation, storage, copying, modification, and deletion of information g) Greater security of information h) Creating inherent value in the information itself.

### SUMMARY

The present invention is a system and method for distributed information processing in a computing environment.

### DRAWINGS

Figures

FIG. 1 is a functional view of the enhanced data container;

FIG. 2 is a functional view of the information processing system layers;

FIG. 3 is a functional view of the Compute layer;

FIG. 4 is a functional view of the Fabric layer;

FIG. 5 is a functional view of the Information layer;

FIG. 6 is a functional view of the management structure;

FIG. 6a is a functional view of the management structure interaction with other components;

FIG. 7 is a functional view of the proof of execution;

FIG. 7a is a functional view of the proof of capability;

FIG. 8 is a functional view of the enhanced data container from the model creation template;

FIG. 9 is a functional view of the enhanced data container;

FIG. 10 is a functional view of the enhanced data container workflow example;

FIG. 11 is a functional view of monetization and rewarding for providing value to the information processing system;

FIG. 12 is a functional view of the enhanced data container with off-system resources and the physical world;

FIG. 13 is a functional view of the enhanced data container interaction with other enhanced data containers;

FIG. 14 is a functional view of emergent behavior enabled enhanced data container interactions;

FIG. 15 is a functional view of biomimicry behavior enabled enhanced data container interactions; and

FIG. 16 is a functional view of enhanced data container and goals;

### DETAILED DESCRIPTION—FIRST EMBODIMENT—FIGS

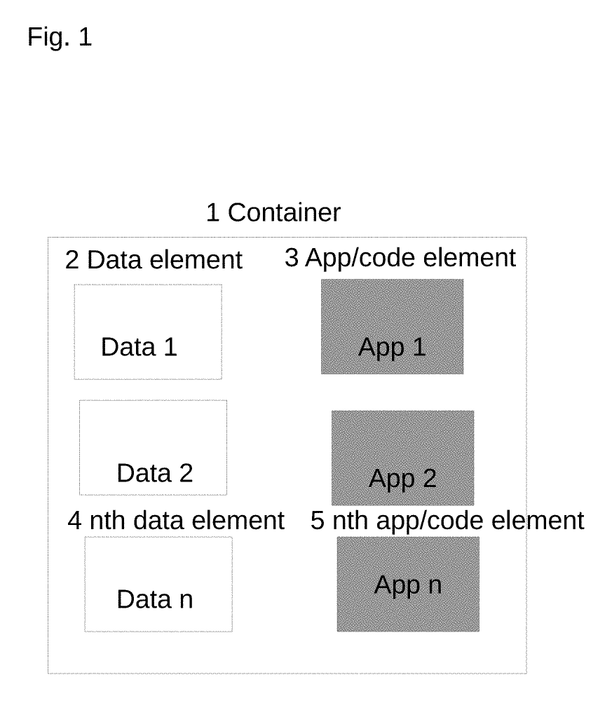

Referring now to the invention in more detail, FIG. 1 shows the generic structure of the enhanced data container 1 and its functional components. The enhanced data container is discussed in more detail in U.S. Pat. No. 9,454,398, entitled “Enhanced data container with extensible characteristics and a system and method of processing and communication of same.” The enhanced data container 1 is a combination of data and application functional components. The enhanced data container 1 may have a single data element 2, or n data elements 4. The enhanced data container 1 may also have a single code element 3, or n code elements 5.

In more detail still referring to FIG. 1 contains an enhanced data container 1 which contains sub elements data element 2, nth data element 4, application/code element 3, and nth application/code element 5. Each subelement can reference any other subelement within the container or in any other enhanced data container 1 or information processing system 1a or fabric 6, 7, 8 element. The enhanced data container 1 or any of its subelements 2, 3, 4, 5 can be encrypted or unencrypted. Functional components of enhanced data container 1 can be any known or unknown data or code structure

The construction detail of the invention as shown in FIG. 1 is as follows. Enhanced data container 1 and all of its components 2, 3, 4, and 5 can be created using any communication technology, compute technology, encryption technology, protocol, programming language, data type, data structure, application code, application structure, data model, data analytics model, artificial intelligence model, machine learning model, and or content type with sufficient capabilities to produce the required functionality.

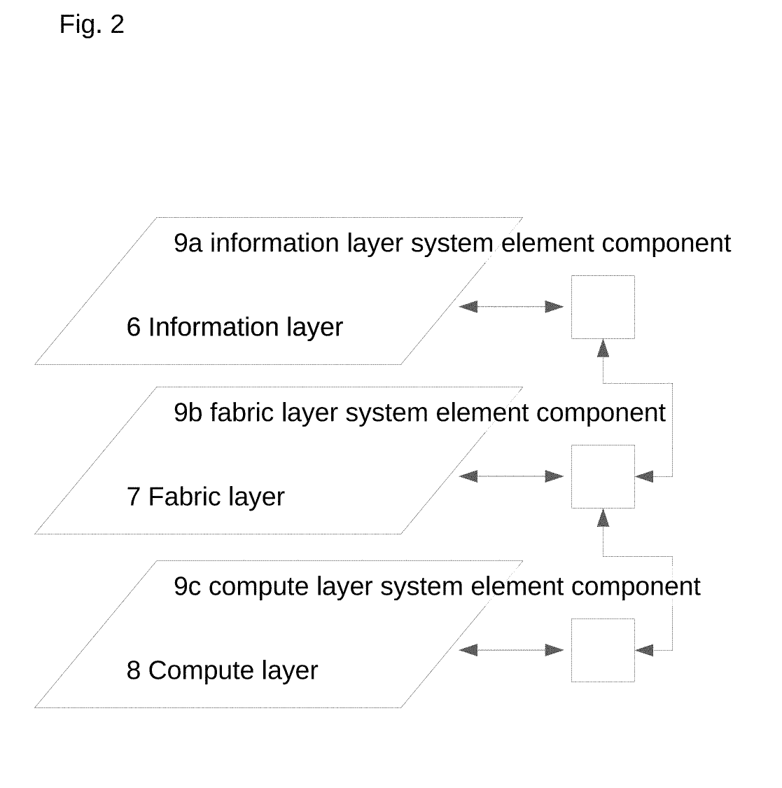

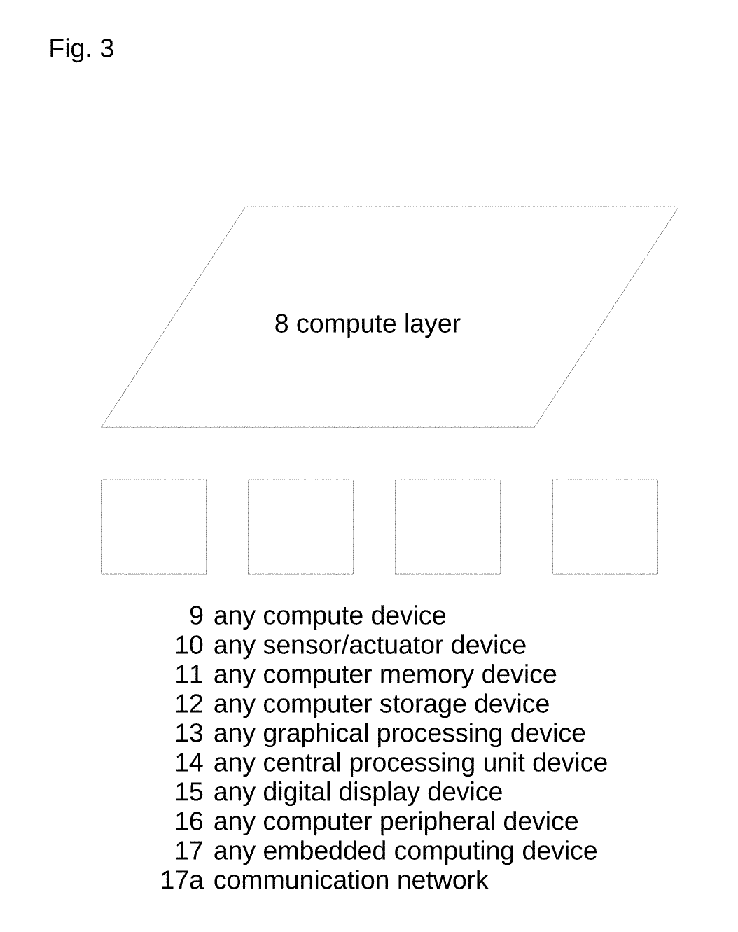

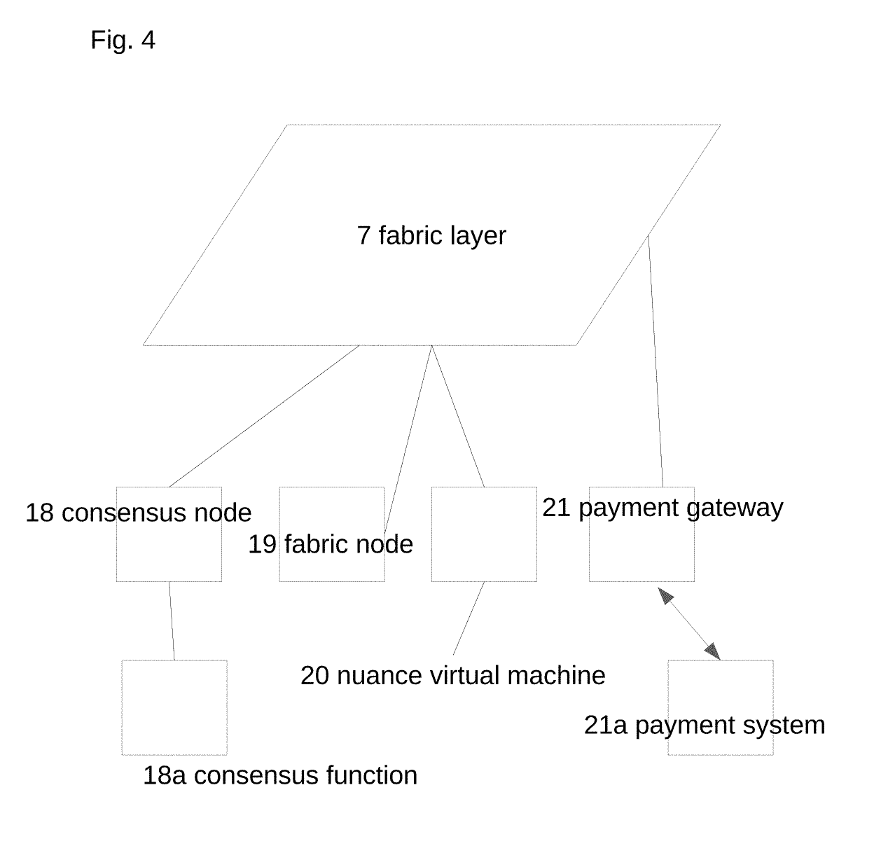

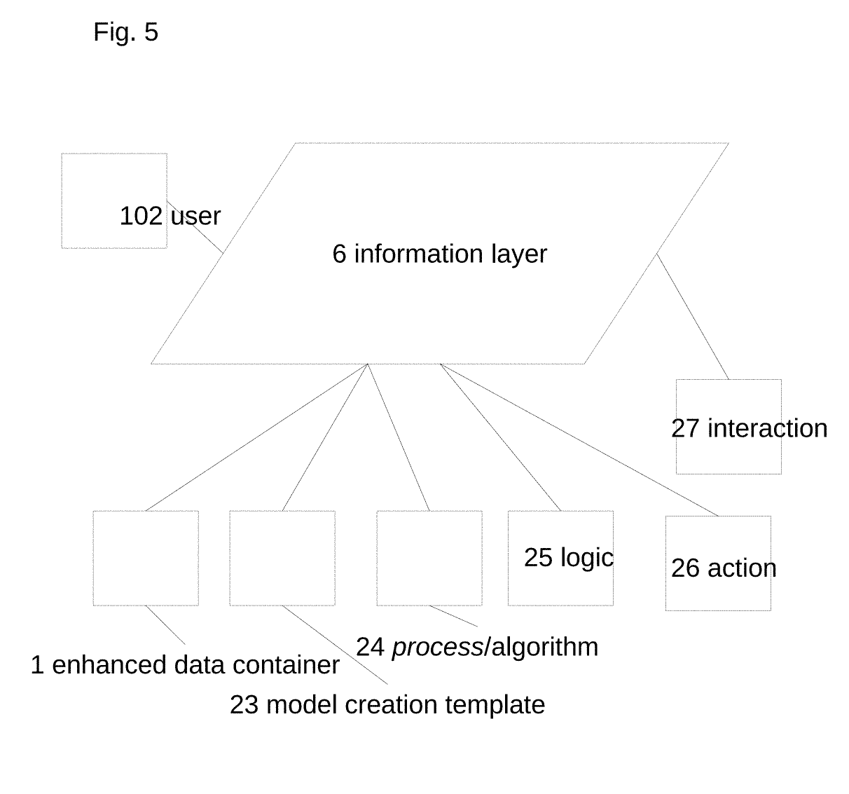

Referring now to the invention in more detail, in FIG. 2 there is shown the 3 functional layers of the information processing system 1a. The compute layer 8 connects to and abstracts compute devices illustrated in FIG. 3. The fabric layer 7 is the function abstraction layer of the information processing network 1a and is illustrated in FIG. 4, and the information layer 6 is where all information processing takes place and is illustrated in more detail in FIG. 5. Additional functional components are the information layer system element component 9a, fabric layer system element component 9b, and the compute layer system element component 9c.

In more detail still referring to FIG. 2, the compute layer 8 is described in FIG. 3. All computational work, all on-fabric storage, and access to all non-fabric resources is handled at or through the compute layer 8. Together the combined elements of the compute layer 8 provide the underpinnings needed for the fabric layer 7.

The fabric layer 7 is described in FIG. 4. The fabric layer 7 is supported by the compute layer 8. The components of the fabric layer 7 are coordinated and secured to provide a secure distributed consensus data store. This provides the underpinnings needed for information layer 6.

The information layer 6 is described in FIG. 5. The information layer 6 is supported by the fabric layer 7 and contains all the information needed to provide an environment in which the enhanced data containers 1 act and interact.

Although the components of the systems are described here and in the more detailed figures as belonging to individual layers, in reality most components have representations across multiple layers. The information layer system element components 9a are intimately tied to the fabric layer system element components 9b which support them. The fabric layer system element components 9b are in turn intimately tied to the compute layer system element components 9c which support them. The result is a complex and potentially evolving hierarchy of components coordinated across the three layers.

The construction detail of the invention as shown in FIG. 2 is as follows. Information Processing system 1a, layers 6, 7, 8 and all components 1, 9a, 9b, and 9c can be created using any communication technology, compute technology, encryption technology, protocol, programming language, data type, data structure, application code, application structure, data model, data analytics model, artificial intelligence model, machine learning model, and or content type with sufficient capabilities to produce the required functionality.

Referring now to the invention in more detail, in FIG. 3 there is shown the compute layer 8 and its functional components. The functional components consist of any compute device 9 any sensor or actuator device 10, any computer memory device 11, any computer storage device 12, any graphical processing unit device 13, any central processing unit device 14, any digital display device 15, any computer peripheral device 16, any embedded compute device 17, and any communication network 17a.

In more detail still referring to FIG. 3, the compute layer 8 consists of all computer resources available to the fabric layer 7 and in formation layer 6. Compute layer 8 is exposed to the fabric layer 7 by fabric nodes 19. Compute layer 8 provides access to all compute resources 9 11 12 13 14 15 16 17 17a, or physical sensors and actuators 10.

The construction detail of the invention as shown in FIG. 3 is as follows. Compute layer 8 and all of its components 9, 10, 11, 12, 13, 14, 15, 16, 17, and 17a, can be created using any communication technology, compute technology, encryption technology, protocol, programming language, data type, data structure, application code, application structure, data model, data analytics model, artificial intelligence model, machine learning model, and or content type with sufficient capabilities to produce the required functionality.

Referring now to the invention in more detail, in FIG. 4 there is shown the fabric layer 7 functional breakout and functional components. The functional components consist of a n number of consensus nodes 18, n number of fabric nodes 19, n number of enhanced container virtual machines 20, and n number of payment gateways 21.

In more detail still referring to FIG. 4, the fabric layer 7 contains abstraction code to interface with both the information layer 6 and the compute layer 8. The fabric layer 7 enables a connected group of compute resources to exchange transactions of enhanced data containers 1. All information layer 6, fabric layer 7, and compute layer 8 resources that are part of the system register with the fabric layer 7 consensus function 18a. Components from the compute layer 8 advertise capabilites that are APIs or digital twins of physical resources or services and the fabric layer 7 makes those capabilities available to enhanced data containers 1 in the information layer 6. The fabric layer 7 processes (executes) enhanced data containers 1, enforces model creation template 23 created rules, enforces management structure 28a rules, manages payment gateway 21 functions, transports enhanced data containers 1 to destination fabric nodes 19 based on enhanced data container 1 rules (24, 25, 26, 27).

The fabric layer 7 contains multiple instances of the following node types that interact with each other, consensus node 18, fabric node 19, enhanced container virtual machine 20, and payment gateway 21. Each node type can be on the same compute device 9, or separate compute devices 9. The consensus node 18 uses some consensus function to have multiple consensus nodes agree that some activity or transaction happened and will record the fact that it happened on some shared transaction record 89. The fabric node 19 contains all functional elements of the fabric layer 7 and fabric layer system element components. The fabric node 19 can run the enhanced container virtual machine, and the payment gateway 21, and the consensus node 18 and consensus function 18a. These functional components can be run together on the same fabric node 19 or separate fabric nodes 19. The enhanced container virtual machine 20 is the execution environment for all information layer 6 elements including the enhanced data container 1, the model creation template 23, and any other information layer system element component 9a. The fabric node 19 also interfaces with any compute layer system element components 9c. The payment gateway 21 is responsible for interfacing with both internal and external payment system 21a.

The construction detail of the invention as shown in FIG. 4 is as follows. The fabric layer 7 and all of its components 1, 18, 18a, 19, 20, 21, 21a, 23, 24, 25, 26, 27, 28, 28a, 9a, 9b, 9c, can be created using any communication technology, compute technology, encryption technology, protocol, programming language, data type, data structure, application code, application structure, data model, data analytics model, artificial intelligence model, machine learning model, and or content type with sufficient capabilities to produce the required functionality.

Referring now to the invention in more detail, in FIG. 5 there is shown the information layer 6 and its functional components. The functional components consist of the enhanced data container 1, a data and application model creation template 23, a processing/algorithm function 24, a logic function 25, an action function (read, actuate) 26, an interaction function 27.

In more detail still referring to FIG. 5, the information layer 6 stores and manages the data and software that runs the whole information processing system 1a. This software takes the form of processes/algorithms 24, logic 25, read/actuate actions 26, and interactions 27, contained and invoked by model creation template 23 and their instantiated enhanced data containers 1. The information layer 6 tracks these software components 1 23 24 25 26 27, their ownership, funds, fees, and their overall state, and is used by those components 1 23 24 25 26 27 to coordinate their interactions. Users 102, developers 43, or enhanced data containers 1 seeking to spawn new enhanced data containers 1 or buy access t existing concepts 23 will do so by interacting with the information layer 6.

The construction detail of the invention as shown in FIG. 5 is as follows. The information layer 6 and all of its components 1, 23, 24, 25, 26, 27, 43, 102 can be created using any communication technology, compute technology, encryption technology, protocol, programming language, data type, data structure, application code, application structure, data model, data analytics model, artificial intelligence model, machine learning model, and or content type with sufficient capabilities to produce the required functionality. User 102 and developer 43 can be a human or an automated process, algorithm or software or enhanced data container 1.

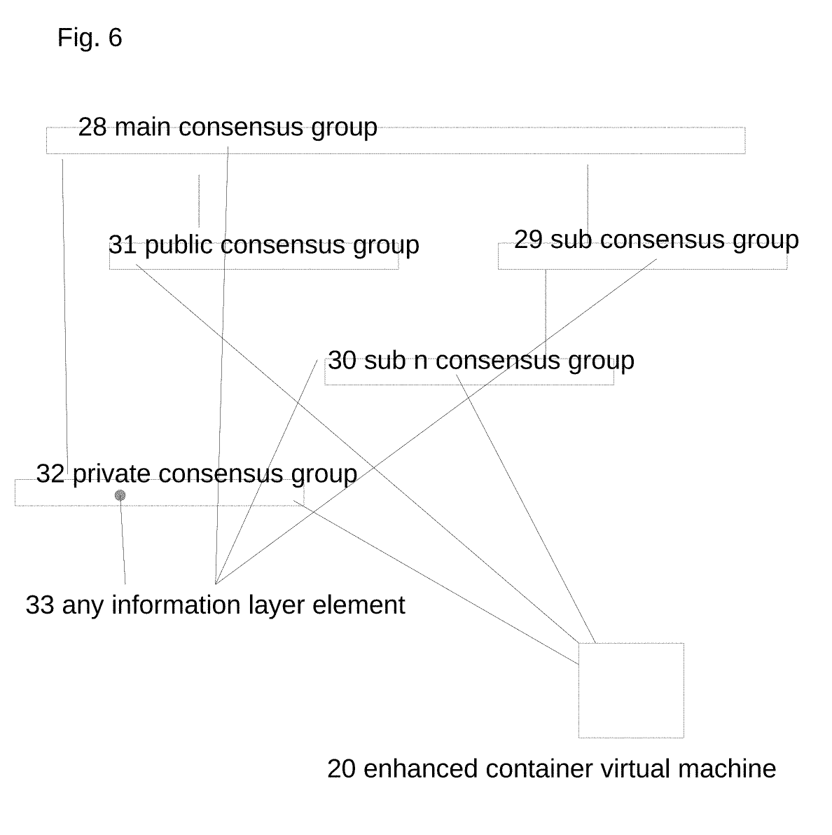

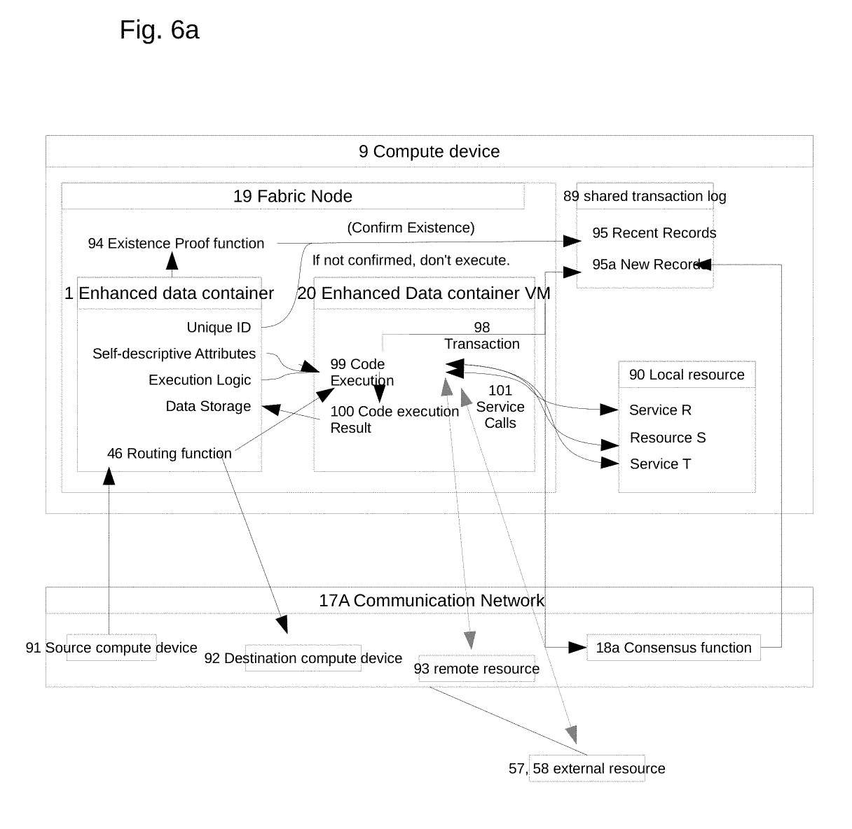

Referring now to the invention in more detail, in FIG. 6 there is shown the information processing network 1a management structure 28a function and its functional components. The functional components consist of a main consensus group 28, any sub consensus group 29, any sub-n consensus group 30, any public consensus group 31, any private consensus group 32, and any information layer element 33.

In more detail still referring to FIG. 6, the Management structure 28a consists of a hierarchy of consensus groups as shown for example with elements 28, 29, 30, 31, and 32. Each consensus group contains the consensus information for that group. This consensus information is a collection containing any number of any information layer element 33. Any consensus group 28, 29, 30, 31, 32 can utilize shared transaction record 89. Any information layer element 33 can reside on any consensus group 28, 29, 30, 31, 32. Consensus group 28, 29, 30, 31, and 32 can run on fabric node 19.

The main consensus group 28 is the top level consensus group. The other consensus groups represented by elements 29, 30, 31, and 32 all depend on the top level consensus group 28. The main consensus group 28 contains any information layer elements 33 which are needed by all participants in the main consensus group and all participants in all sub consensus groups.

Enhanced container virtual machines 20 participate in consensus groups in order to add and gain access to any information layer elements 33 stored in the consensus groups. An enhanced container virtual machine 20 can participate in multiple consensus groups. As an example, in the figure the enhanced container virtual machine 20 is participating in the consensus groups represented by elements 30, 31, and 32.

Sub consensus groups 29 are created by spawning from an existing consensus group, in this example from the main consensus group 28. This process can be repeated indefinitely thus producing the sub n consensus groups 30. Multiple sub consensus groups 29 can spawn from any consensus group. As an example, in this figure elements 20, 31, and 32 have all spawned from the main consensus group 28.

When a sub consensus group 29 is spawned, it may be configured to be in many ways different from the consensus group from which is spawned. For example it may use different rules for validating changes to the consensus information. As another example, it may use different rules for establishing a consensus among the participants. As a final example, it may use different rules about what enhanced container virtual machines 20 are allowed to participate in the consensus group, thus creating a private consensus group 32. Many other configuration differences are possible and they can be combines in many ways. These examples are not to be taken as exhaustive.

As mentioned a private consensus group 32 may be formed by spawning a sub consensus group 29 with specific rules about what enhanced container virtual machines 20 can participate in the private consensus group 32. A public consensus group 31 would have much more permissive rules, but might for example have more strict rules for reporting and traceability.

When an enhanced container virtual machine 20 participates in a consensus group it gains access to the information in all consensus groups higher in the hierarchy. The enhanced container virtual machine 20 must still comply with all rules of the consensus group in order to add or modify information in that consensus group, even if the enhanced container virtual machine 20 is participating in that consensus group via it's participation in a consensus group lower in the hierarchy.

The construction detail of the invention as shown in FIG. 6 is as follows. information processing network 1a management structure 28a and all of its components 29, 30, 31, 32, 33, 20, can be created using any communication technology, compute technology, encryption technology, protocol, programming language, data type, data structure, application code, application structure, data model, data analytics model, artificial intelligence model, machine learning model, consensus model, blockchain technology, and or content type with sufficient capabilities to produce the required functionality.

Referring now to the invention in more detail, in FIG. 6a there is shown the system management structure 28a functional diagram and it's functional components. Functional components include any compute device 19, any enhanced data container 1, any communication network 17a, any routing function 46, an enhanced data container virtual machine 20, any consensus function 18a, a shared transaction log 89, any source compute device 91, any destination compute device 92, any local resource 90 of the compute device 9, a remote resource 93, and external resources 57, and 58.

In more detail still referring to FIG. 6a the system management structure 28a operates within any computer device 9 and all layers 6, 7, 8. A fabric node 19 processes an enhanced data container 1 with the enhanced data container virtual machine 20. The enhanced data container virtual machine 20 can access local resources 90 consisting of resources and service on compute device 9, remote resource 93 on communication network 17a on information processing system 1a, or external resource 57, 58 with a read or write function using service call 101. Enhanced data container 1 contains an existence proof function processed by the enhanced data container virtual machine 20 and validated in the shared transaction log 89. Both fabric node 19 and enhanced data container virtual machine use 99 code execution, code execution result 100 and shared transaction log 89 to process recent records 95 and participate in consensus function 18a with other compute devices 9 and fabric nodes 19 over communication network 17a to update new records 95a with transaction 98.

In more detail, Fabric node 19 receives enhanced data container 1 from source compute device 91 over communication network 17a. The enhanced data container virtual machine 20 processes routing function 46 and fabric node 19 forwards enhanced data container 1 to destination compute device 92 over communication network 17a.

The construction detail of the invention as shown in FIG. 6a is as follows. System management structure 28a and all of its components 1a, 6, 7, 8, 9, 17a, 18a, 19, 20, 57, 58, 89, 90, 91, 92, 95, 95a, 98, 99, 100, 101 can be created using any communication technology, compute technology, encryption technology, protocol, programming language, data type, data structure, application code, application structure, data model, data analytics model, artificial intelligence model, machine learning model, and or content type with sufficient capabilities to produce the required functionality.

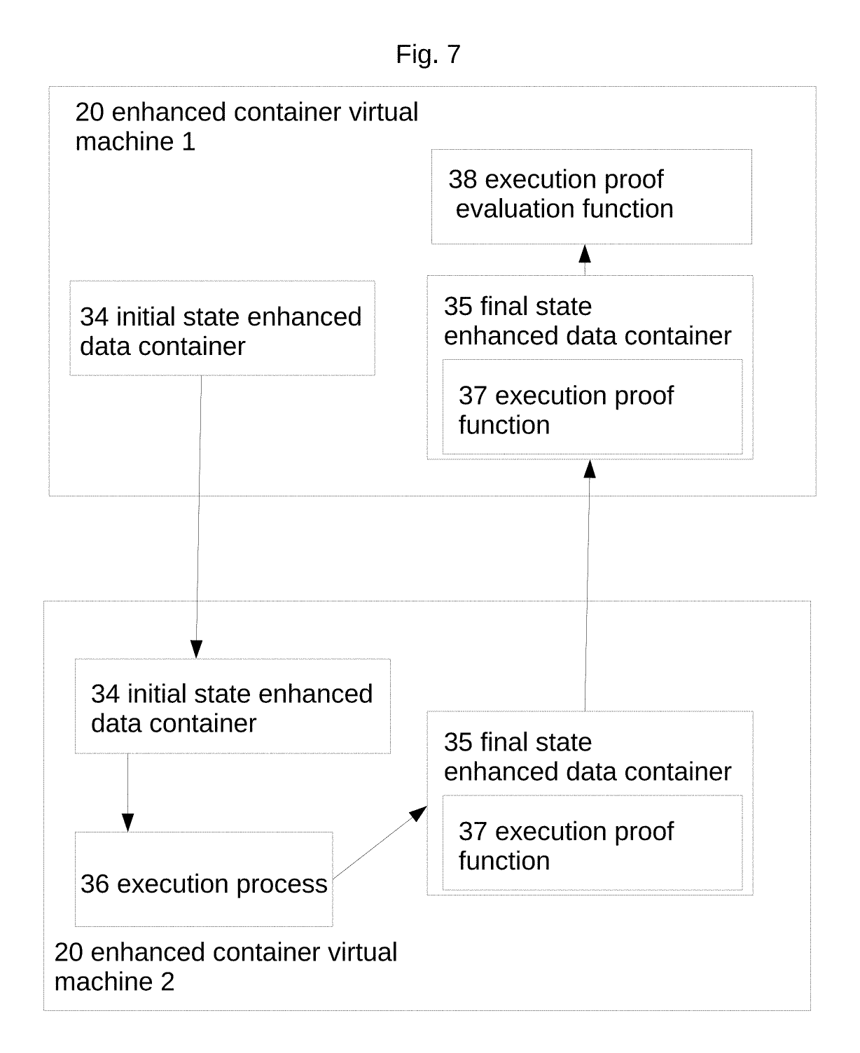

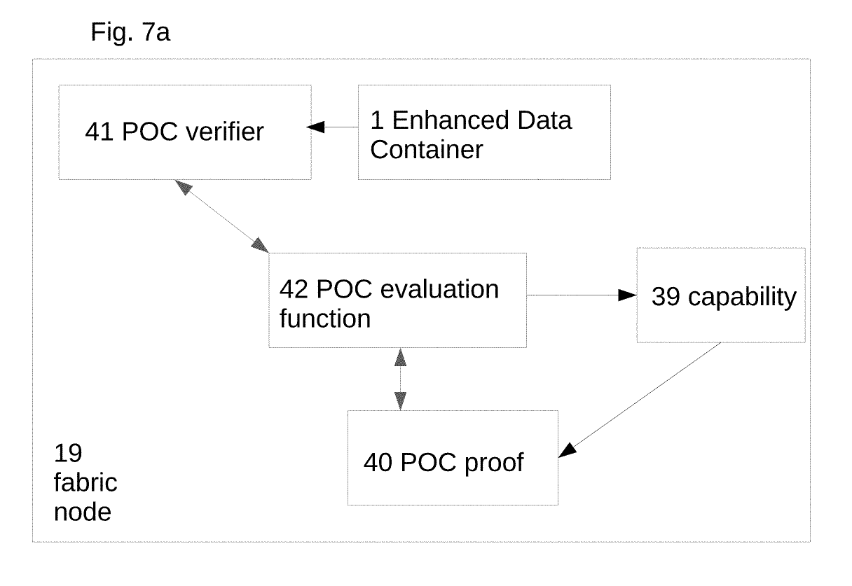

Referring now to the invention in more detail, in FIG. 7 there is shown the validation of execution function and its functional components. The functional components consist of an initial state of the enhanced data container 34, the final state of the enhanced data container 35, the execution process 36, the execution proof function 37, and the execution proof evaluation function 38. These functions operate within the enhanced container virtual machine function 20.

In more detail still referring to FIG. 7, the enhanced container virtual machine 20 processes the executable process 36 contained in the initial state nuance 34 in order to produce the final state nuance 35. The method for processing the executable process 36 is described in FIG. 2 above.

Proof of execution requires that the act of processing the executable process 36 be independently verifiable by the sending enhanced container virtual machine 20. To verify that the enhanced container virtual machine 20 is honest about its processing, it will be asked to hand back a mathematical proof in the form of the execution proof function 37 to the originating enhanced container virtual machine 20 either as part of or separate from the final state data container 35. The original sending enhanced container virtual machine 20 can use this execution proof function 37 to verify that the execution process 36 performed the execution as expected by evaluating the execution proof function 37 using the execution proof evaluation function 38. The execution proof function 37 may be distributed amongst enhanced container virtual machines 20 in a random order fashion with each enhanced container virtual machine 20 processing the execution proof function 37 independently.

The construction detail of the invention as shown in FIG. 7 is as follows. Proof of execution and all of its components 34, 35, 36, 37, 38 can be created using any communication technology, compute technology, encryption technology, protocol, programming language, data type, data structure, application code, application structure, data model, data analytics model, artificial intelligence model, machine learning model, and or content type with sufficient capabilities to produce the required functionality.

Referring now to the invention in more detail, in FIG. 7a there is shown the validation of capability function and its functional components. The functional components consist of some capability 39, the capability proof function 40, the capability proof verifier 41, and the proof of capability evaluation function. These functional components reside within the fabric node function 19.

In more detail still referring to FIG. 7a, an enhanced data container 1 that arrives at a fabric node 19 will verify that the fabric node 19 has the capabilities 39 that it requires to execute. When the fabric node 19 is initialized, each configured capability 39 will provide a proof of capability proof function 40 that unambiguously proves the existence of the capability 39. The fabric node 19 uses a proof of capability evaluation function 42 that executes all of the proof of capability proofs 40 for all configured capabilities 39. When the enhanced data container 1 needs to verify a given capability 39, it will use the fabric node 19's proof of capability verifier 41 function to query the proven capabilites 39. If the required capability 39 exists on the fabric node 19, the enhanced data container 1 can be executed by that fabric node 19.

The construction detail of the invention as shown in FIG. 7a is as follows. Proof of capability and all of its components 39, 40, 41, 42, 19, 1 can be created using any communication technology, compute technology, encryption technology, protocol, programming language, data type, data structure, application code, application structure, data model, data analytics model, artificial intelligence model, machine learning model, and or content type with sufficient capabilities to produce the required functionality.

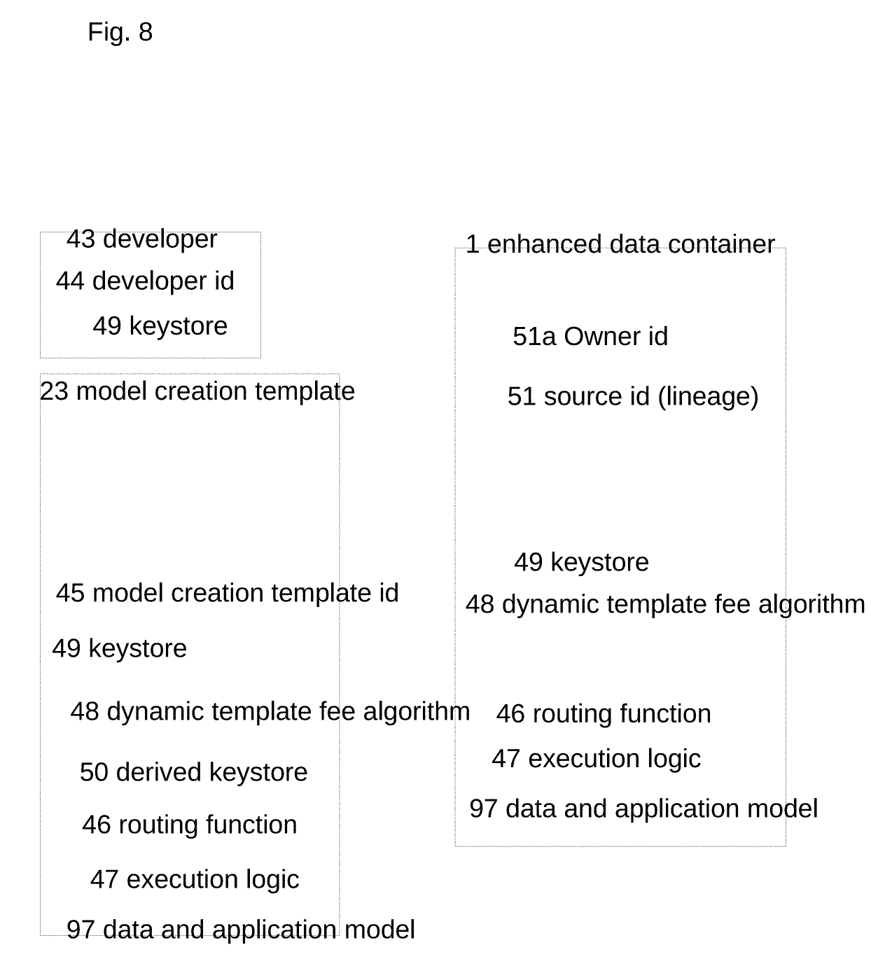

Referring now to the invention in more detail, in FIG. 8 is the functional view of a model creation template 23 creating an enhanced data container 1 and its functional components. The functional components consist of an enhanced data container 1, a model creation template 23, a developer 43 [developer can be a person or a function that creates the developer function? yes?], a developer id 44, a model creation template id 45, routing function 46, execution logic 47, dynamic template fee algorithm 48, a single or multiple keystore(s) 49, a single or multiple derived keystore 50, and an enhanced data container source id 51.

In more detail still referring to FIG. 8 which illustrates the relationship between a developer 43, the model creation template 23, and an enhanced data container 1. Developer 43 can be a human developer or any automated developer SDK or assistance platform or any other automated platform that can create a model creation template. The developer 43 has a unique developer identifier 44 and unique keystore 49. The keystore 49 gives that developer 43 access to certain features of the information processing system 1a. The keystore 49 in other contexts gives any information processing system element 96 access to any other information system element 96. [might need to move this last sentence somewhere else]. The model creation template 23 has a unique model creation template id 45, it's own keystore 49, and some derived keystore 50 derived from the keystore 49. The model creation template 23 also contains a dynamic template fee algorithm 48 used to generate fees for various elements of the model creation template 23 or the model creation template 23 itself. In more detail the model creation template 23 also contains 0, 1 or more of the following a routing function 46, execution logic 47, and a data and application model 97. Each of these function 46, 47, and 97 can be any known or unknown programmatic data and application code or structure such as an analytics or artificial intelligence model.

A model creation template 23 creates one or more enhanced data containers 1 containing either direct copies of elements from model creation template 23, 48, 49, 46, 47, 97, or algorithmically derived values from model creation template 23 subbasements and functions. The enhanced data container 1 also has both a unique owner identifier, and a unique source identifier derived from the model creation template 23 and developer identifier 44 which can in turn be used to derive sub identifiers.

The construction detail of the invention as shown in FIG. 8 is as follows. All of the components 1, 23, 43, 44, 45, 46, 47, 48, 49, 50, 51, 51a, 97 can be created using any communication technology, compute technology, encryption technology, protocol, programming language, data type, data structure, application code, application structure, data model, data analytics model, artificial intelligence model, machine learning model, and or content type with sufficient capabilities to produce the required functionality. User 102 and developer 43 can be a human or an automated process, algorithm or software or enhanced data container 1.

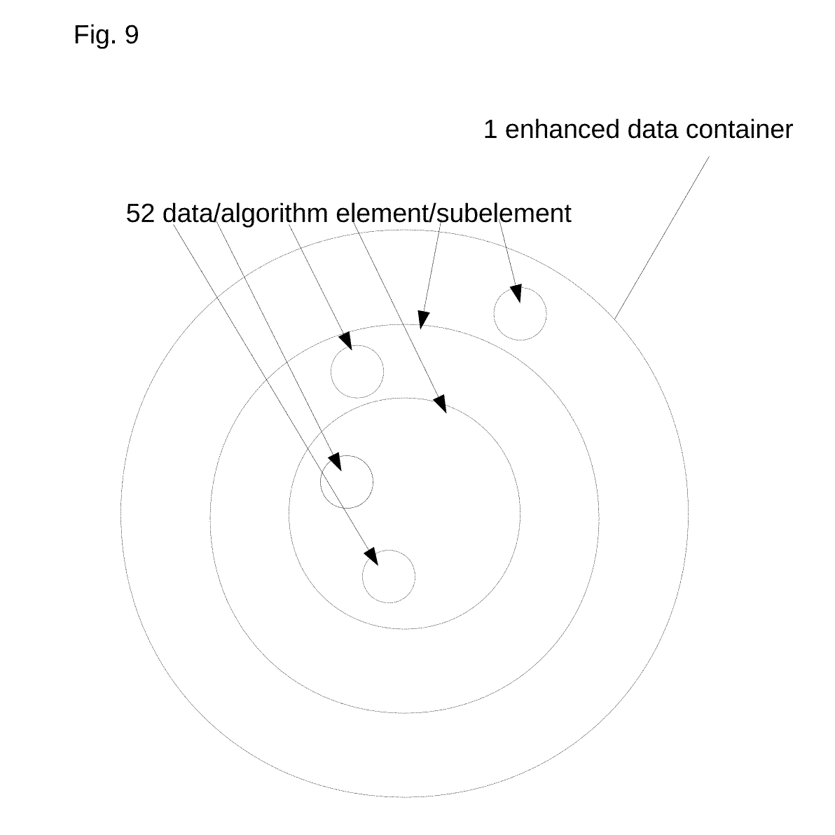

Referring now to the invention in more detail, in FIG. 9 there is shown the structure of a layered enhanced data container 1 and its functional components. The functional components consist of zero or more data/algorithm element/subbasement(s) 52 and zero or more enhanced data container(s) 1.

In more detail still referring to FIG. 9, the enhanced data container 1 can have arbitrary structure internally. Elements/subelements 52 can be data structures, algorithms such as analytics or artificial or data analytics model elements, access control or authorization, keystore 49, 50 information, etc. It may even contain another enhanced data container 1. These subelements 52 may be encrypted or unencrypted, and any algorithms or code 52 included in the enhanced data container 1 may be able to access any other subelement 52 of the enhanced data container 1.

The construction detail of the invention as shown in FIG. 9 is as follows. Enhanced data container 1 and all of the components 49, 50, 52 can be created using any communication technology, compute technology, encryption technology, protocol, programming language, data type, data structure, application code, application structure, data model, data analytics model, artificial intelligence model, machine learning model, and or content type with sufficient capabilities to produce the required functionality.

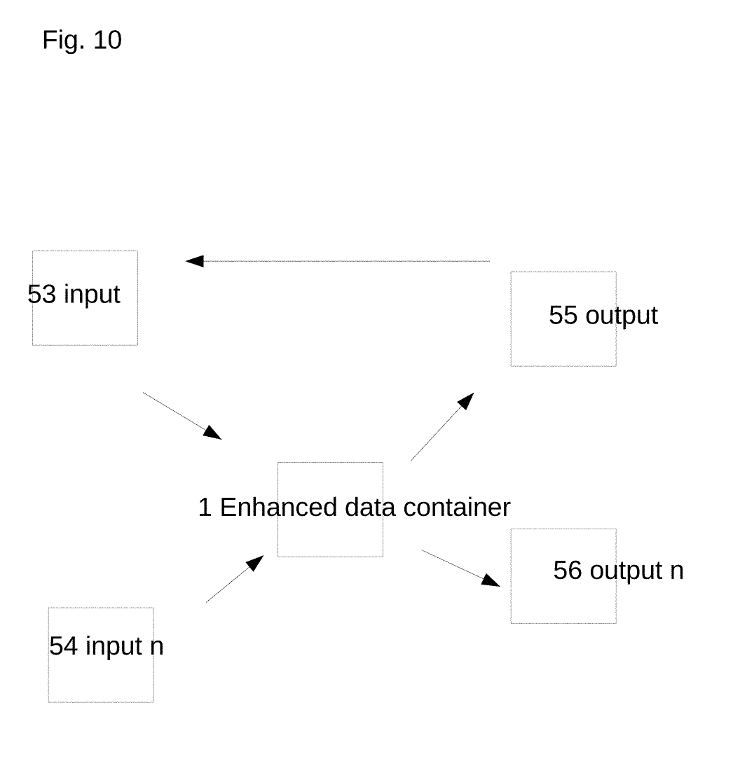

Referring now to the invention in more detail, in FIG. 10 there is shown a functional workflow of an enhanced data container 1 processing n number of inputs, input 1 53 to input n 54, n number of outputs, ouput 1 55 to output n 56.

In more detail still referring to FIG. 10, the enhanced data container 1 can accept unrequested input n 54, or generate output n 56, or generate output 56 which results in input 53. Any of these inputs 53 54 or outputs 55 56 can be but are not limited to data read or sent, sensor 10 data consumed, actions sent to physical actuators 10 or compute resources 9 11 12 13 14 15 16 17 17a, analytics performed, messages exchanged with other enhanced data containers 1, software code patches applied to a compute resource 9 11 12 13 14 15 16 17 17a or to the enhanced data container 1 itself.

The construction detail of the invention as shown in FIG. 10 is as follows. Enhanced data container 1 and all of the components 53, 54, 55, 56, 9 11 12 13 14 15 16 17 17a can be created using any communication technology, compute technology, encryption technology, protocol, programming language, data type, data structure, application code, application structure, data model, data analytics model, artificial intelligence model, machine learning model, and or content type with sufficient capabilities to produce the required functionality.

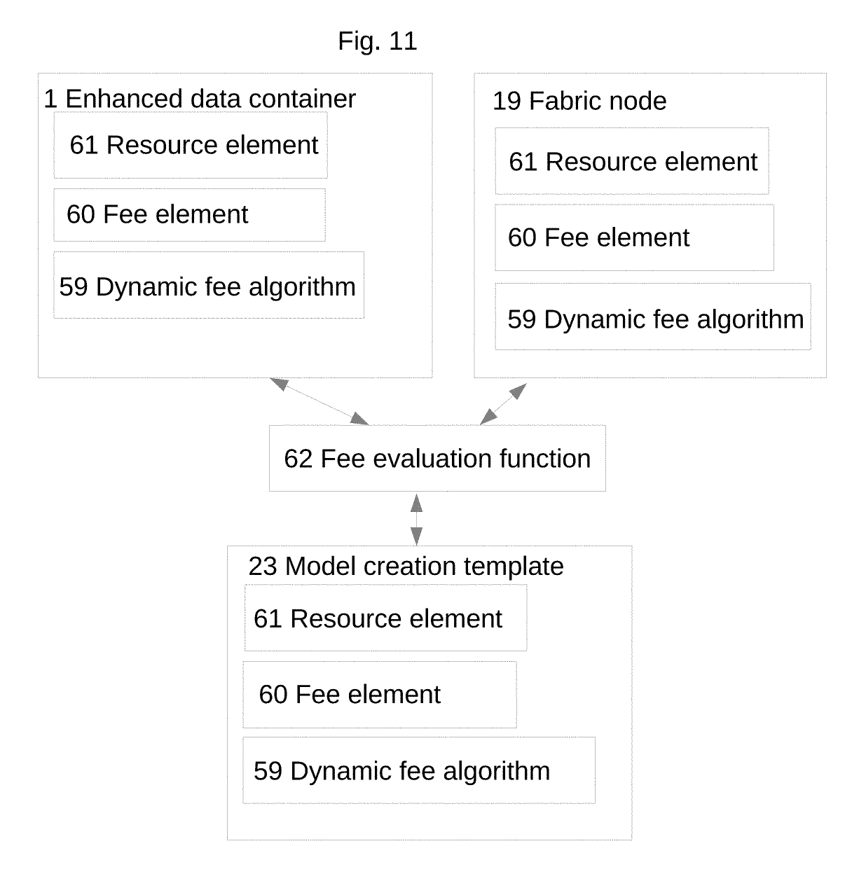

Referring now to the invention in more detail, in FIG. 11 there is shown a functional structure of assigning monetary value to any resource in the information processing system 1a and its functional components. Functional components include the enhanced data container 1, fabric node 19, model creation template 23, a dynamic fee algorithm 59, a fee element 60, any information processing system 1a resource element 61 and a fee evaluation function 62.

In more detail still referring to FIG. 11, the system implements monetization of its elements in the following areas, the enhanced data container 1, the fabric node 19, and the model creation template 23.

In the case of the enhanced data container 1, one or more resource elements 61 may be deemed to be of monetary value. This could, for example, include items of data or logic contained within the enhanced data container 1. In order to assign value to these resource elements 61, the enhanced data container 1 will contain a fee element 60 which enumerates the value of the corresponding resource element 60. A fee evaluation function 62 is provided by the system that will use a dynamic fee algorithm 59 referenced or provided by the enhanced data container 1 to calculate the fee assessed for access to the resource element 61. This dynamic fee algorithm 59 may refer to external data or conditions as well as the fee element 60 to calculate the fee.

For example, an enhanced data container 1 may contain data in resource elements 60 about temperatures collected from various sensors, and algorithms to perform trend analysis on those temperatures. The enhanced data container 1 may also contain a fee element 61 assigning a value to the analyzed data. A process or system may request access to that data, at which time, the fee evaluation function 62 would calculate and assess a fee for that data access.

In the case of the fabric node 19, one or more resource elements 61 may be deemed to be of monetary value. This could, for example, include hardware or software functionality or data items hosted by the fabric node 19. In order to assign value to these resource elements 61, the fabric node 19 will contain a fee element 60 which enumerates the value of the corresponding resource element 60. A fee evaluation function 62 is provided by the system that will use a dynamic fee algorithm 59 referenced or provided by the fabric node 19 to calculate the fee assessed for access to the resource element 61. This dynamic fee algorithm 59 may refer to external data or conditions as well as the fee element 60 to calculate the fee.

For example, the fabric node 19 may include temperature sensors described in resource elements 60. An enhanced data container 1 may request access to the data from those sensors. The fee evaluation function 62 would use the dynamic fee algorithm 59 provided or referenced by the fabric node 19 to calculate and assess the fee for that resource access.

In the case of the model creation template 23, one or more resource elements 61 may be deemed to be of monetary value. This could, for example, include items of data or logic contained within model creation template 23 that define the structure of an enhanced data container 1. In order to assign value to these resource elements 61, the model creation template 23 will contain a fee element 60 which enumerates the value of the corresponding resource element 60. A fee evaluation function 62 is provided by the system that will use a dynamic fee algorithm 59 referenced or provided by the model creation template 23 to calculate the fee assessed for access to the resource element 61. This dynamic fee algorithm 59 may refer to external data or conditions as well as the fee element 60 to calculate the fee.

For example, a model creation template 23 may define a set of algorithms to collect and analyze temperature data. A system user may wish to create one or more enhanced data containers 1 based on this model creation template 23. The fee evaluation function 62 would use the dynamic fee algorithm 59 provided or referenced by the model creation template 23 to calculate and assess the fee for that enhanced data container 1 creation.

The construction detail of the invention as shown in FIG. 11 is as follows. All of the components 1, 19, 23, 59, 60, 61, 62 can be created using any communication technology, compute technology, encryption technology, protocol, programming language, data type, data structure, application code, application structure, data model, data analytics model, artificial intelligence model, machine learning model, cryptocurrency coin, cryptocurrency token, payment transaction, payment transaction record, digital currency, currency, and or content type with sufficient capabilities to produce the required functionality.

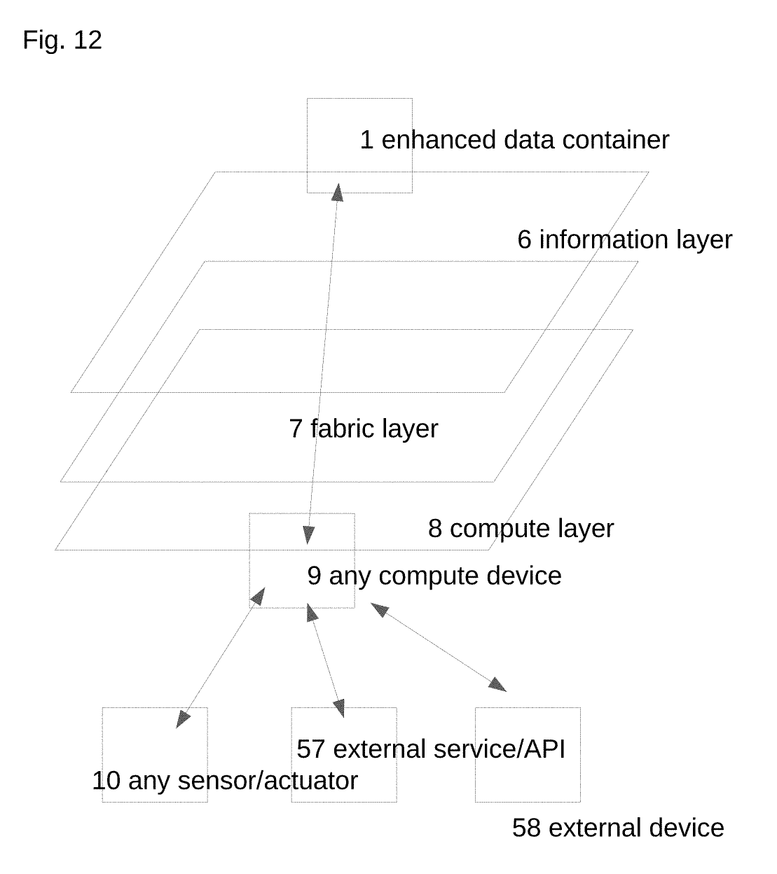

Referring now to the invention in more detail, in FIG. 12 there is shown a functional structure of an enhanced data container 1 accessing and interacting with an external resource and its functional components. Functional components include the enhanced data container 1, the information layer 6, the fabric layer 7, the compute layer 8, any compute device 9, any sensor/actuator 10, any external service/API 57, and any external device 58.

In more detail still referring to FIG. 12, any enhanced data container 1 accesses resources external to information processing system 1a by interfacing with information layer 6, fabric layer 7, and computer layer 8 via any compute device 9 to interact with any sensor/actuator 10, any external service/API 57 or any external device 58, including but not limited to reading from or sending information to 10, 57, or 59 via any communication network 17a or protocol.

The construction detail of the invention as shown in FIG. 12 is as follows. All of the components 1, 7, 8, 9, 17a, 57, 58, 59 can be created using any communication technology, compute technology, encryption technology, protocol, programming language, data type, data structure, application code, application structure, data model, data analytics model, artificial intelligence model, machine learning model, and or content type with sufficient capabilities to produce the required functionality.

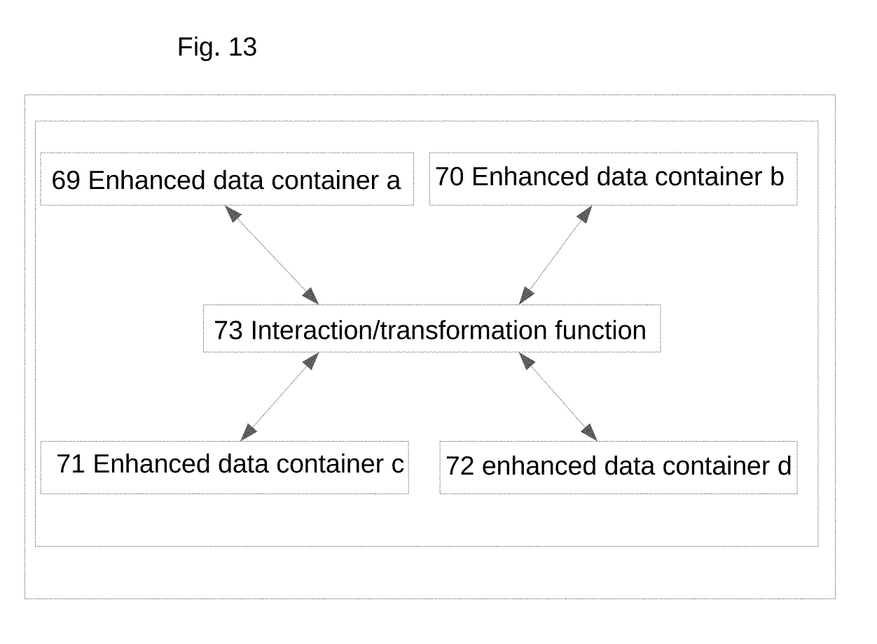

Referring now to the invention in more detail, in FIG. 13 there is shown a functional structure of an enhanced data container 1 interacting with a second or many other enhanced data containers 1 and its functional components. Functional components include enhanced data container a 69, enhanced data container b 70, enhanced data container c 71, enhanced data container d 72, and an interaction and transformation function 73.

In more detail still referring to FIG. 13, enhanced data containers 1 carry data elements 2 and app code elements 3 (see FIG. 1) on an individual basis but often act in groups when performing tasks or completing goal sets. Thus, enhanced data containers 1 must have the ability to contain, create, destroy, and modify other enhanced data containers 1. Enhanced data containers 1 may copy, exchange or swap characteristics or information from other enhanced data containers 1. Single or multiple enhanced data containers 1 can affect single or multiple target enhanced data containers 1. These transformations and interactions are carried out by an interaction/transformation function 73 that may be defined in the enhanced data container 1, the enhanced container virtual machine 20, or the fabric node 19.

Examples of this capability include but are not limited to: Spawning: enhanced data container a 69 may employ the interaction/transformation function 73 to create an offspring, enhanced data container b 70. Splitting: enhanced data container a 69 may employ the interaction/transformation function 73 to divide its elements into enhanced data container c 71 and enhanced data container d 72. Merging: enhanced data container a 69 and enhanced data container b 70 may employ the interaction/transformation function 73 to produce a combined enhanced data container c 71. Evolving: enhanced data container a 69 may employ the interaction/transformation function 73 to modify its own elements in accordance with rules defined in its own elements, or those contained in another enhanced data container b 70. Digital DNA: enhanced data container a 69 and enhanced data container b 70 may employ the interaction/transformation function 73 to exchange data elements and origin information in such a way that the exchanged information may be traced back to its source. Modification: enhanced data container a 69 may employ the interaction/transformation function 73 to change the characteristics of enhanced data container b 70. Termination: enhanced data container a 69 may use the interaction/transformation function 73 to destroy enhanced data container b 70, given that enhanced data container a 69 has the authority to destroy enhanced data container b 70, such as by being the creator of that container or its ancestors (see Spawning above).

Each of these operations on enhanced data containers a, b, c, and d 69, 60, 71, 72 are recorded such that a history of all interactions and transformations is maintained.

The construction detail of the invention as shown in FIG. 13 is as follows. All of the components 1, 2, 3, 19, 20, 69, 70, 71, 72, and 73 can be created using any communication technology, compute technology, encryption technology, protocol, programming language, data type, data structure, application code, application structure, data model, data analytics model, artificial intelligence model, machine learning model, and or content type with sufficient capabilities to produce the required functionality.

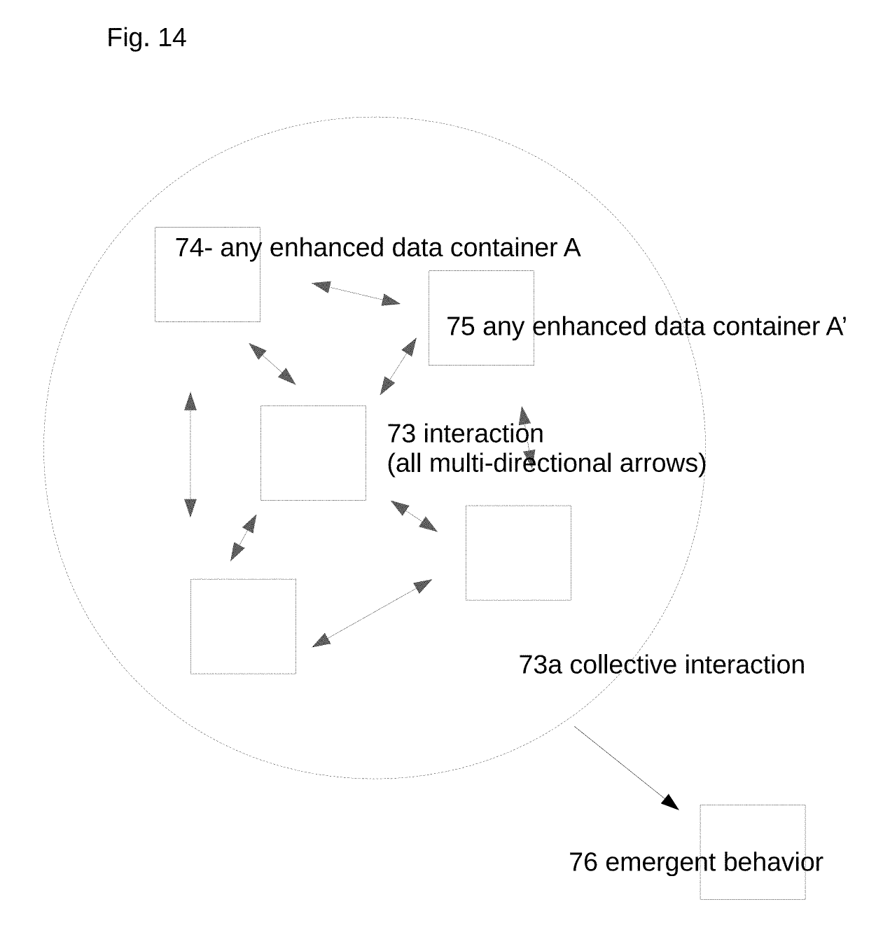

Referring now to the invention in more detail, in FIG. 14 illustrates a functional structure of emergent behaviors resulting from multiple enhanced data containers 1 interacting and it's functional components. Functional components include any enhanced data container A 74, any enhanced data container A′ 75, an interaction 73, a collective interaction 73a, and an emergent behavior 76.

In more detail still referring to FIG. 14, enhanced data containers 1 engage in interaction 73 as a part of their otherwise independent function. Interaction 73 is the transfer between enhanced data containers 1 of any information, data, instruction, or message, by any means. Together, these interactions 73 combine to form collective interaction 73a. The collective result of the collective interaction 73a is emergent behavior 76.

The collection of enhanced data containers 1 might consist entirely of a single type. In this case any enhanced data container A 74 would engage in interaction 73 only with other any enhanced data container A 74. In this figure we show two types of enhanced data container 1, such that any enhanced data contain A 74 engages in interaction 73 with any enhanced data contain A′ 75. In the general case, there can be an arbitrary number of types of enhanced data container 1 all engaging in interaction 73. Regardless of the number of enhanced data containers 1, types of enhanced data container 1, or the nature or means of the interaction 73, whenever there is a collective interaction 73a there there is the potential for emergent behavior 76.

The construction detail of the invention as shown in FIG. 14 is as follows. All of the components 1, 73, 73a, 74, 75, 76 can be created using any communication technology, compute technology, encryption technology, protocol, programming language, data type, data structure, application code, application structure, data model, data analytics model, artificial intelligence model, machine learning model, and or content type with sufficient capabilities to produce the required functionality.

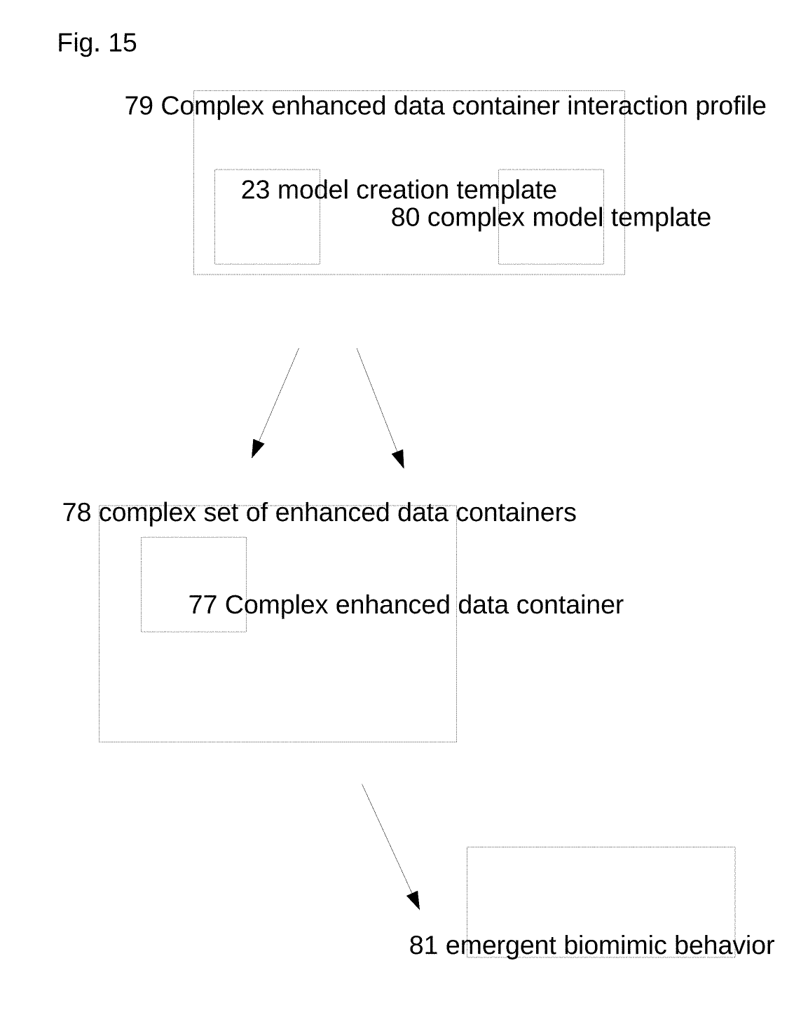

Referring now to the invention in more detail, in FIG. 15 there is shown a functional structure of enhanced data containers 1 producing emergent biomimic behavior and it's functional components. Functional components include the model creation template 23, a complex model template 80, a complex enhanced data container interaction profile 79, any complex enhanced data container 77, a complex set of enhanced data containers 78, and an emergent biomimic behavior 81.

In more detail still referring to FIG. 15, a model creation template 23 and a complex model template 80 together produce a complex enhanced data container interaction profile 79. The complex enhanced data container interaction profile 79 is a collection of interactions 73 chosen such that the collective interaction 73a produces a complex result.

Enhanced data containers 1 created using such complex enhanced data container profiles 79 and complex model template 80 are complex enhanced data containers 77. A collection of these complex enhanced data containers 77 are together a complex set of enhanced data containers 78. The complex result of the collective interaction 73a of the complex set of enhanced data containers 78 is some emergent biomimic behavior 81. Examples of such emergent biomimic behavior 81 include, but are not limited to, the swapping of internal components or genes, flocking and schooling, the formation of processing networks similar to neurons, neural networks, cellular functions, and immune function.

The construction detail of the invention as shown in FIG. 15 is as follows. All of the components 73, 73a, 77, 78, 79, 80, can be created using any communication technology, compute technology, encryption technology, protocol, programming language, data type, data structure, application code, application structure, data model, data analytics model, artificial intelligence model, machine learning model, and or content type with sufficient capabilities to produce the required functionality.

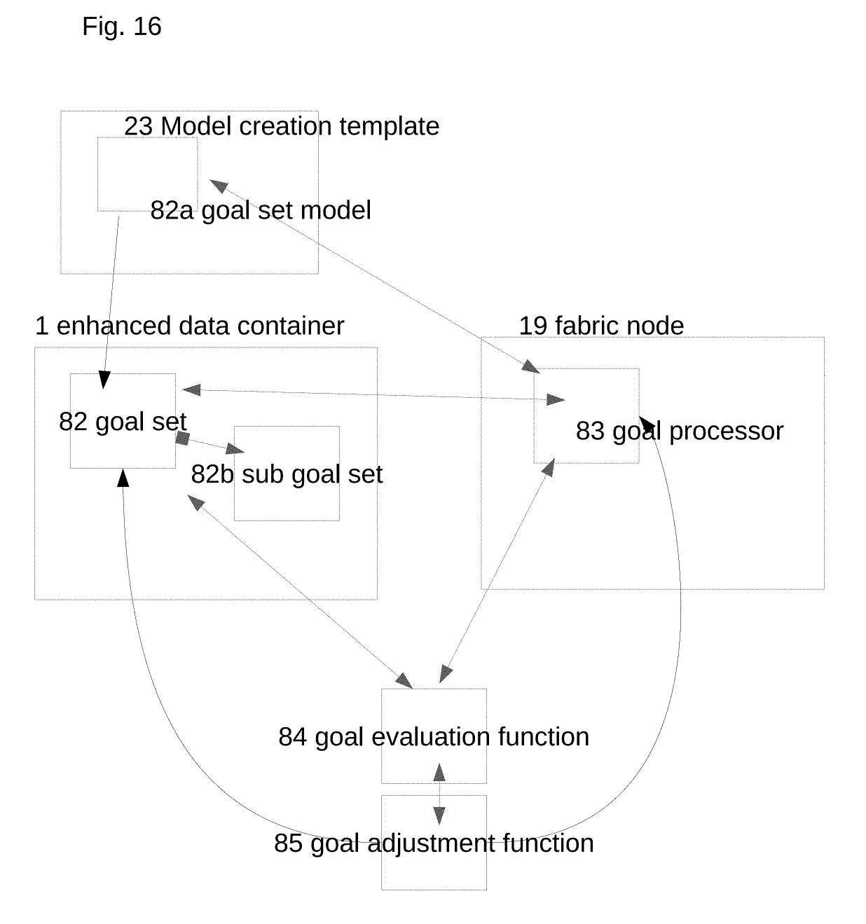

Referring now to the invention in more detail, in FIG. 16 there is shown a goal processing and adjustment functional structure and it's functional components. Functional components include an enhanced data container 1, a fabric node 19, a goal set 82, a goal processor 83, a goal evaluation function 84, and a goal adjustment function 85.

In more detail still referring to FIG. 16 an enhanced data container contains a goal set 82 that is either copied directly from or derived from goal set model 82a contained in creation template 23. Goal set 82 is processed by goal processor 83 in fabric node 19. A goal evaluation function 84 compares the output of the goal processor 83 and compares it to goal set 82. Goal adjustment function 85 analyzes the output of goal evaluation function 84 and sends instructions to goal processor 83 to make any required adjustments to goal set 82 in enhanced data container 1 or goal set model 82a in model creation template 23. Goal set models 82a and goal sets 82 can be defined by or relate to the information processing system 1a as a whole, a specific layer 6, 7, 8, an single or multiple enhanced data container 1, or any model creation template 23. A goal set 82 is defined as a set of sequence of actions that allows an agent in this case an enhanced data container to achieve a particular goal, where a particular sequence of actions depends on both the goal and the current state of the enhanced data container 1 and it's interactions with other enhanced data containers 1 and any other information processing system 1a elements. Goal set 82 may be fully contained within a single enhanced data container 1 or distributed among multiple enhanced data containers 1 or any other information processing system 1a elements. Goal sets 82 and goal set models 82a can also undergo interactions such as but not limited to splitting, merging, evolving, creating sub goal set 82b via goal processor 83 and can be simple or complex goal sets and can be artificial intelligence or machine learning goal sets 82 82a 82b.

The construction detail of the invention as shown in FIG. 16 is as follows. All of the components 1, 19, 23, 82, 82a, 82b, 83, 84, and, can be created using any communication technology, compute technology, encryption technology, protocol, programming language, data type, data structure, application code, application structure, data model, data analytics model, artificial intelligence model, machine learning model, and or content type with sufficient capabilities to produce the required functionality.

### CONCLUSION, RAMIFICATIONS, AND SCOPE

The advantages of the present invention include, without limitation, the ability to create interesting and unique combinations and or characteristics of information, algorithms, data, applications, content, and computer device interactions to create value. Further advantages include, without limitation, the ability to create hierarchical classifications of combinations and or characteristics and to validate the integrity of the information, data, contents, and source of an individual instance of the invention.

In broad embodiment, the present invention is an enhanced data container and the system and method of processing and communication of the enhanced data container in a computing environment.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

The invention claimed is:

1. A system for creating and processing information using a computing device, the system comprising: a. an enhanced data container
